(19) United States
(12) Patent Application Publication
(10) Pub. No.: US 2013/0071745 A1
(43) Pub. Date: Mar. 21, 2013

(54) ELECTRODE ACTIVE MATERIAL, PREPARATION METHOD THEREOF, AND ELECTRODE AND LITHIUM BATTERY CONTAINING THE SAME

(71) Applicants: Jun-young MUN, Seoul (KR); Won-chang Choi, Yongin-si (KR); Jin-hwan Park, Seoul (KR)

(72) Inventors: Jun-young MUN, Seoul (KR); Won-chang Choi, Yongin-si (KR); Jin-hwan Park, Seoul (KR)

(73) Assignee: SAMSUNG ELECTRONICS CO., LTD., Suwon-si (KR)

(21) Appl. No.: 13/545,540

(22) Filed: Jul. 10, 2012

(30) Foreign Application Priority Data
Sep. 19, 2011 (KR) 10-2011-0094277

(51) Int. Cl. H01M 4/1315; H01M 4/36; H01M 4/133; H01M 4/134; H01M 4/136

(52) U.S. Cl. 429/219; 429/209; 429/220; 429/221; 429/223; 429/224; 429/229; 429/231.5; 429/231.9; 429/231.1; 429/231.2; 429/231.3; 429/231.6; 429/231.8; 252/182.1

(57) ABSTRACT

An electrode active material, a method of manufacturing the same, and an electrode and a lithium battery utilizing the same. The electrode active material includes a core capable of intercalating and deintercalating lithium and a coating layer formed on at least a portion of a surface of the core, wherein the coating layer includes a composite metal halide having a spinel structure.

### CROSS-REFERENCE TO RELATED APPLICATIONS

This application claims the benefit of Korean Patent Application No. 10-2011-0094277, filed on Sep. 19, 2011, in the Korean Intellectual Property Office, the disclosure of which is incorporated herein in its entirety by reference.

### BACKGROUND

1. Field

Aspects of the present invention relate to an electrode active material, a preparation method thereof, and an electrode and a lithium battery including the same.

2. Description of the Related Art

For smaller and higher performance devices, it is important to increase the energy density of a lithium battery, in addition to decreasing the size and weight thereof. That is, a high-voltage and high-capacity lithium battery has become important. For realizing a lithium battery satisfying these requirements, research is being conducted on cathode active materials having high voltage and high capacity.

When typical cathode active materials having high voltage and high capacity are used, side reactions, such as elution of a transition metal and generation of gas, occur at a high temperature and/or a voltage higher than about 4.4 V. Due to these side reactions, the performance of a battery is degraded in a high temperature and high voltage environment. Therefore, methods of preventing degradation of a battery in a high temperature and high voltage environment are required.

### SUMMARY

Aspects of the present invention provide electrode active materials capable of preventing performance degradation of a battery under a high temperature and high voltage conditions.

Aspects of the present invention provide electrodes including the electrode active materials.

Aspects of the present invention provide lithium batteries utilizing the electrodes.

Aspects of the present invention provide lithium batteries utilizing the electrodes.

Aspects of the present invention provide methods of manufacturing the electrode active materials.

According to an aspect of the present invention, an electrode active material may include a core capable of intercalating and deintercalating lithium; and a coating layer formed on at least a portion of a surface of the core, wherein the coating layer may include a composite metal halide containing an alkali metal and a metal with an oxidation number of 2 or higher.

According to another aspect of the present invention, an electrode may include the electrode active material.

According to another aspect of the present invention, a lithium battery may include the electrode.

According to another aspect of the present invention, a method of manufacturing an electrode active material may include preparing a resultant by contacting metal halide or its precursor containing an alkali metal and a metal with an oxidation number of 2 or higher to a core including a cathode active material or an anode active material; and optionally sintering the resultant.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1A illustrates the result of an X-ray diffraction (XRD) experiment on Li₃AlF₆ synthesized only by mixing LiF and AlF₃ at a ratio of about 3:1, and sintering the mixture at a temperature of 800° C. for about 12 hours;

FIG. 1B illustrates the result of an X-ray diffraction (XRD) experiment on Li₂TiF₆ synthesized only by mixing H₂TiF₆ and Li₂CO₃ at a ratio of about 1:1, and sintering the mixture at a temperature of 800° C. for about 12 hours;

FIG. 2 illustrates the transmission electron microscope (TEM) image of the cathode active material prepared in Example 1;

FIG. 3 illustrates results of high rate characteristics experiment on lithium batteries manufactured according to Examples 82 to 84 and Comparative Example 7; and

FIG. 4 is a schematic diagram illustrating a lithium battery according to an embodiment.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures. As used herein, the term “and/or” includes any and all combinations of one or more of the associated listed items.

Hereinafter, an electrode active material, a manufacturing method thereof, and an electrode and a battery including the same, according to exemplary embodiments, will be described in detail.

An electrode active material, according to an embodiment, includes a core capable of intercalating and deintercalating lithium; and a composite metal halide including a coating layer formed on at least a portion of the core, wherein the coating layer contains an alkali metal and a metal with an oxidation number of 2 or higher. That is, by coating at least a portion of a surface of the core capable of intercalating and deintercalating lithium with the composite metal halide containing the metal with an oxidation number of 2 or higher, the coating layer may be formed on at least a portion or all of the core surface.

Since the composite metal halide practically is not involved in a battery capacity, the coating layer including the composite metal halide may serve, for example, as a protective layer of the core. That is, the coating layer may serve to suppress a side reaction between the core and an electrolyte. The coating layer may also serve to prevent transition metal erupting from the core capable of intercalating and deintercalating lithium. Moreover, when the composite metal halide includes lithium as an alkali metal, surface resistance of the electrode active material may reduce since the composite metal halide may have conductivity with respect to lithium ions.

The composite metal halide includes a stronger metal-halogen bonding than a typical oxide including metal-oxide bonding, for example CaO and FeO, and an oxide having a corundum crystal structure, for example Al₂O₃, Fe₂O₃, FeTiO₃, and MgO. Therefore, a stable coating layer may be formed under a high temperature and high voltage condition.

For example, the composite metal halide may be one or more metal halides selected from the group of metal halides expressed as the following Formula 1:

AₐMeX_{b}, <Formula 1>

where A is one or more selected from the group consisting of lithium (Li), sodium (Na), and potassium (K); Me is one or more metal selected from the group consisting of aluminum (Al), iron (Fe), titanium (Ti), zirconium (Zr), scandium (Sc), vanadium (V), chrome (Cr), manganese (Mn), cobalt (Co), nickel (Ni), copper (Cu), zinc (Zn), molybdenum (Mo), ruthenium (Ru), lanthanum (La), hafnium (Hf), niobium (Nb), germanium (Ge), silver (Ag), tungsten (W), and silicon (Si); X is a halogen; a is an integer from 1 to 3; and b is an integer from 4 to 6.

For example, the composite metal halide may be one or more metal halides selected from the group consisting of Li₂TiF₆, Na₂TiF₆, K₂TiF₆, Li₂ZrF₆, Na₂ZrF₆, K₂TiF₆, Li₃AlF₆, Na₃AlF₆, K₃TiF₆, Li₃FeF₆, NaFeF₆, Na₃FeF₆, Na₂AlF₆, K₃AlF₆, K₃FeF₆, K₂ZrF₆, LiₓNa₂₋ₓTiF₆(0<x<2), Li_{y}K_{1-y}TiF6(0<y<1), Li₂Zr_{0.5}Ti_{0.5}F₆, Li₃Al_{0.5}Fe_{0.5}F₆, Li₃MoF₆, Li₂MoF₆, LiMoF₆, and Li₃HfF₆.

The composite metal halide content may be about 10 wt% or less, for example, may be about 5 wt% or less based on the total weight of the electrode active material. For example, the composite metal halide content may be larger than 0 to about 10 wt%. For example, the composite metal halide content may be larger than 0 to about 5 wt%. For example, the composite metal halide content may be larger than 1 to about 5 wt%.

The coating layer of the electrode active material may include one or more elements selected from the group consisting of alkali metals, one or more elements selected from the group consisting of metals with an oxidation number of 2 or higher, and one or more elements selected from the group consisting of halogens. The metals with an oxidation number of 2 or higher may be selected from the group consisting of Al, Fe, Ti, Zr, Sc, V, Cr, Mn, Co, Ni, Cu, Zn, Mo, Ru, La, Hf, Nb, Ge, Ag, W and Si. For example, when the coating layer disposed on the surface of the electrode active material is analyzed with inductively coupled plasma mass spectrometry (ICP) or the like, the elements mentioned above may be detected.

The content of the one or more elements included in the coating layer may be selected from the group consisting of metals with an oxidation number of 2 or higher and may be about 10 wt% or less, for example, may be larger than 0% and up to about 10 wt% based on the total weight of electrode active material. For example, the content may be larger than 0% and up to about 6 wt%.

In the coating layer, the composition ratio of halogen element to one or more elements selected from the group consisting of metal with an oxidation number of 2 or higher may be about 3.5:1 to about 6.5:1. For example, the composition ratio may be about 3.8:1 to about 6.2:1. For example, the composition ratio may be about 3.9:1 to about 6.1:1. For example, the composition ratio may be about 4:1 to about 6:1. The composition ratio corresponds to the composition ratio of X to Me in the composite metal halide having a composition formula of AₐMeX_{b} in the coating layer.

In the coating layer, the composition ratio of alkali metal element to one or more elements selected from the group consisting of metals with an oxidation number of 2 or higher may be about 0.5:1 to about 3.5:1. For example, the composition ratio may be about 0.8:1 to about 3.2:1. For example, the composition ratio may be about 0.9:1 to about 3.1:1. For example, the composition ratio may be about 1:1 to about A device used to perform the ICP experiment was the model ICPS-8100 of Shimadzu Corporation. A composition ratio of. The composition ratio corresponds to a composition ratio of A to Me in the composite metal halide having a composition formula of AₐMeX_{b} in the coating layer.

The composite metal halide including the alkali metal and the metal with an oxidation number of 2 or higher may not substantially intercalate or deintercalate lithium. Thus, the composite metal halide may not substantially be involved in a battery capacity.

The thickness of the coating layer of the electrode active material may range from about 1 Å to about 1 μm. For example, the thickness of the coating layer may range from about 1 nm to about 100 nm. For example, the thickness of the coating layer may range from about 1 nm to about 30 nm. For example, the thickness of the coating layer may range from about 2 nm to about 15 nm. A lithium battery of an enhanced performance may be provided from the ranges of thickness of the coating layer.

The average particle diameter of the core of the electrode active material may range from about 10 nm to about 500 μm. For example, the average particle diameter of the core may range from about 10 nm to about 100 μm. For example, the average particle diameter of the core may range from about 10 nm to about 50 μm. For example, the average particle diameter of the core may range from about 1 μm to about 30 μm. A lithium battery of an enhanced performance may be provided from the ranges of the particle diameter.

The core capable of intercalating and deintercalating lithium in the electrode active material may include a cathode active material. The cathode active material may be a lithium transition metal oxide. Any lithium transition metal oxide for a cathode of a lithium battery that is used in the art may be used as the lithium transition metal oxide. For example, the lithium transition metal oxide may have a spinel structure, a layered structure or an olivine structure.

The lithium transition metal oxide may be a single compound or a composite of two or more compounds. For example, the lithium transition metal oxide may be a composite of two or more compounds having layered-structures. For example, the lithium transition metal oxide may be a composite or a solid solution of a compound having a layered-structure and a compound having a spinel-structure.

The lithium transition metal oxide may include overlithiated transition metal oxide (OLO) or lithium transition metal oxide with an average operating voltage about 4.3 V or higher. For example, the average operating voltage of the lithium transition metal oxide may range from about 4.3 V to about 5.0 V. The average operating voltage means a value obtained by dividing a charge/discharge electric energy by a charge/discharge quantity of electricity when a battery is charged and discharged to an upper limit and a lower limit of a charge/discharge voltage at a recommendation operating voltage of the battery.

The core may include, for example, compounds expressed as the following Formulae 2 and 3.

Li[LiₐMe₁₋ₐ]O_{2+d} <Formula 2>

Li[Li_{b}Me_{c}M′_{e]O}_{2+d}, <Formula 3>

where 0<a<1, b+c+e=1; 0<b<1, 0<e<0.1; 0≦d≦0.1, Me is one or more metals selected from the group consisting of Ti, V, Cr, Mn, Fe, Co, Ni, Cu, Al, Mg, Zr, and B, and M′ is one or more metals selected from the group consisting of Mo, W, Ir, Ni, and Mg.

Also, the core may include compounds expressed by the following Formulae 4 to 8.

LiₓCo_{1-y}M_{y}O_{2-α}X_{α} <Formula 4>

LiₓCo_{1-y-z}Ni_{y}M_{z}O_{2-α}X_{α} <Formula 5>

LiₓMn_{2-y}M_{y}O_{4-α}X_{α} <Formula 6>

LiₓCo_{2-y}M_{y}O_{4-α}X_{α} <Formula 7>

LiₓMe_{y}M_{z}PO_{4-α}X_{α}, <Formula 8>

where 0.90≦x≦1.1, 0≦y≦0.9, 0≦z≦0.5, 1−y−z>0, 0≦α≦2, Me is one or more metals selected from the group consisting of Ti, V, Cr, Mn, Fe, Co, Ni, Cu, Al, Mg, Zr, and B, M is at least one element selected from the group consisting of Mg, Ca, Sr, Ba, Ti, Zr, Nb, Mo, W, Zn, Al, Si, Ni, Mn, Cr, Fe, Mg, Sr, V, and rare-earth elements, and X is an element selected from the group consisting of O, F, S, and P.

Also, the core may include compounds expressed by the following Formulae 9 and 10.

pLi₂MO₃—(1−p)LiMeO₂ <Formula 9>

xLi₂MO_{3-y}LiMeO₂—zLi_{1+d}M′_{2-d}O₄, <Formula 10>

where 0<p<1, x+y+z=1; 0<x<1, 0<y<1, 0<z<1; 0≦d≦0.33,M is one or more metals selected from the group consisting of Mg, Ca, Sr, Ba, Ti, Zr, Nb, Mo, W, Zn, Al, Si, Ni, Mn, Cr, Fe, Mg, Sr, V, and rare-earth elements, Me is one or more metals selected from the group consisting of Ti, V, Cr, Mn, Fe, Co, Ni, Cu, Al, Mg, Zr, and B, and M′ is one or more metals selected from the group consisting of Ti, V, Cr, Mn, Fe, Co, Ni, Cu, Al, Mg, Zr, and B.

A compound of Formula 8 may have a layered-structure, and Li₂MO₃—LiMeO₂ and Li_{1+d}M′_{2-d}O₄ as compounds of Formula 9 may have a layered-structure and a spinel-structure, respectively.

The core capable of charging and discharging lithium in the electrode active material may include an anode active material. The anode active material may include one or more materials selected from the group consisting of lithium metal, a metal which is alloyable with lithium, a transition metal oxide, a non-transition metal oxide, and a carbonaceous material. Any anode active material for a lithium battery which is used in the art may be used as the anode active material.

For example, the metal, which is alloyable with lithium, may be Si, Sn, Al, Ge, Pb, Bi, Sb, Si—T alloy, (where T is an alkali metal, alkali earth metal, group 13 element, group 14 element, transition metal, rare-earth metal, or a combination thereof, and is not Si), and Sn—Z alloy (where Z is an alkali metal, alkali earth metal, group 13 element, group 14 element, transition metal, rare-earth metal, or a combination thereof, and is not Sn). The elements T and Z may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, G. Se, Te, Po, or a combination thereof. The transition metal oxide may be lithium titanium oxide, vanadium oxide, or lithium vanadium oxide. The non-transition oxide may be SnO₂ or SiOₓ (0<x<2).

The carbonaceous material may be crystalline carbon, amorphous carbon, or a combination thereof. The crystalline carbon may be natural graphite of amorphous type, plate type, flake type, spherical type, or fiber type, or synthetic graphite. The amorphous carbon may be soft carbon (low-temperature-sintered carbon), hard carbon, mesophase pitch carbide, or sintered coke.

The coating layer of the electrode active material may be formed by contacting the composite metal halide containing a metal with an oxidation number of 2 or higher or its precursor with the core and optionally sintering the precursor of the composite metal halide and the core. That is, the electrode active material, in which the composite metal halide is coated on the core, is prepared by contacting the composite metal halide containing a metal with an oxidation number of 2 or higher or its precursor with the core capable of intercalating and deintercalating lithium and optionally sintering the precursor of the composite metal halide and the core. When the precursor of the composite metal halide is used, a sintering process may be i necessary.

An electrode according to another embodiment may include the electrode active material described above. The electrode may be a cathode or an anode.

The cathode may be manufactured as follows. A cathode active material composition is prepared by mixing a cathode active material having a coating layer including a composite metal halide containing an alkali metal and a metal with an oxidation number of 2 or higher formed on at least a portion of a surface thereof, a conducting agent, a binder, and a solvent. The cathode active material composition may be directly coated on an aluminum current collector and dried for manufacturing a cathode plate on which a cathode active layer is formed. Differently, the cathode active material composition may be cast on a separate support, and then the resulting film peeled from the support is laminated on an aluminum current collector for manufacturing a cathode plate on which a cathode active layer is formed.

As the conducting agent, carbon black, natural graphite, artificial graphite, acetylene black, , carbon fiber; metal powder, metal fiber, or metal tube such as carbon nanotube, copper, nickel, aluminum, and silver; and conductive polymer such as polyphenylene derivatives may be used; however, the conducting agent is not limited thereto, and any conducting agent used in the art may be used.

As the binder, vinylidene fluoride/hexafluoropropylene co-polymer, polyvinylidene fluoride (PVDF), polyacrylonitrile, poly(methyl methacrylate), polytetrafluoroethylene (PTFE), mixture of the foregoing polymers, and styrene-butadiene rubber polymer may be used, and as the solvent, N-methylpyrrolidone (NMP), acetone, and water may be used; however, the solvent is not limited thereto, and any material used in the art may be used. Contents of the cathode active material, the conducting agent, the binder, and the solvent may be typical levels used for a lithium battery.

The cathode may further include a typical cathode active material as well as a cathode active material of which a coating layer is formed including the composite metal halide. The typical cathode active material may be any material used as a cathode that may intercalate and deintercalate lithium.

The anode may be manufactured using the same method as that for the cathode except that an anode active material instead of a cathode active material is used. For example, the anode may be manufactured as follows. An anode active material composition is manufactured by mixing an anode active material having a coating layer including a composite metal halide containing an alkali metal and a metal with an oxidation number of 2 or higher formed on at least a portion of a surface thereof, a conducting agent, a binder, and a solvent. The anode active material composition may be directly coated on a copper current collector for manufacturing an anode plate. The anode active material composition may also be cast on a separate support, and then the anode active material film peeled from the support is laminated on a copper current collector to manufacture an anode plate.

The same conducting agent, binder, and solvent as in the cathode may be used for the anode active material. According to circumstances, a plasticizer may be added to the cathode active material composition and the anode active material composition to form pores in an electrode plate.

Contents of the anode active material, the conducting agent, the binder, and the solvent may be typical levels used for a lithium battery. According to the intended use and structure of the lithium battery, one or more of the conducting agent, the binder, and the solvent may be omitted. Also, the anode may further include a typical anode active material as well as an anode active material of which a coating layer is formed including the composite metal halide. The typical anode active material may be any material used as an anode that may intercalate and deintercalate lithium may be used.

A lithium battery according to another embodiment adopts the electrode. The lithium battery may include one or more of a cathode and an anode for an electrode including a composite metal halide. The lithium battery, for example, may be manufactured as follows. First, a cathode and/or an anode according to an embodiment are manufactured as described above. The manufacturing method is the same as the method mentioned above except that, when the cathode or the anode does not include a composite metal halide, it uses an electrode active material that does not include a composite metal halide. Next, a separator to be inserted between the cathode and the anode is prepared.

Any separator typically used for a lithium battery may be used. A separator which has low resistance to ion movement of an electrolyte and has an excellent ability in containing an electrolyte solution may be used. For example, the separator may be selected from glass fiber, polyester, polyethylene, polypropylene, PTFE, or a combination thereof, wherein the selected separator may be a non-woven fiber type or a woven fiber type separator. For example, a windable separator such as polyethylene and polypropylene may be used for a lithium-ion battery, and a separator having an excellent ability in containing an organic electrolyte solution may be used for a lithium-ion polymer battery.

For example, the separator may be manufactured as follows. A separator composition is prepared by mixing a polymer resin, a filler, and a solvent. The separator composition may be directly coated on an electrode and dried for forming the separator. Alternatively, the separator composition may be caste on a support and dried, and then the separator film peeled from the support may be laminated on an electrode for forming the separator.

The polymer resin used for manufacturing the separator is not particularly limited, and thus, any material used as a bonding material of an electrode plate may be used. For example, vinylidene fluoride/hexafluoropropylene co-polymer, PVDF, polyacrylonitrile, poly(methyl methacrylate), or a combination thereof may be used.

Next, an electrolyte is prepared. The electrolyte may be an organic electrolyte solution. The electrolyte may also be a solid. For example, the electrolyte may be boron oxide or lithium oxynitride; however, it is not limited thereto, and any solid electrolyte used in the art may be used. The solid electrolyte may be formed on the anode by using a sputtering method.

An organic electrolyte solution may be prepared. The organic electrolyte solution may be manufactured by dissolving lithium salt in an organic solvent. Any organic solvent used in the art may be used for the organic solvent. For example, propylene carbonate, ethylene carbonate, fluoroethylene carbonate, butylene carbonate, dimethyl carbonate, diethyl carbonate, ethyl methyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane. N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, or a combination thereof may be used.

Any lithium salt used in the art may be used for the lithium salt. For example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are natural numbers), LiCl, Lil, or a combination thereof may be used.

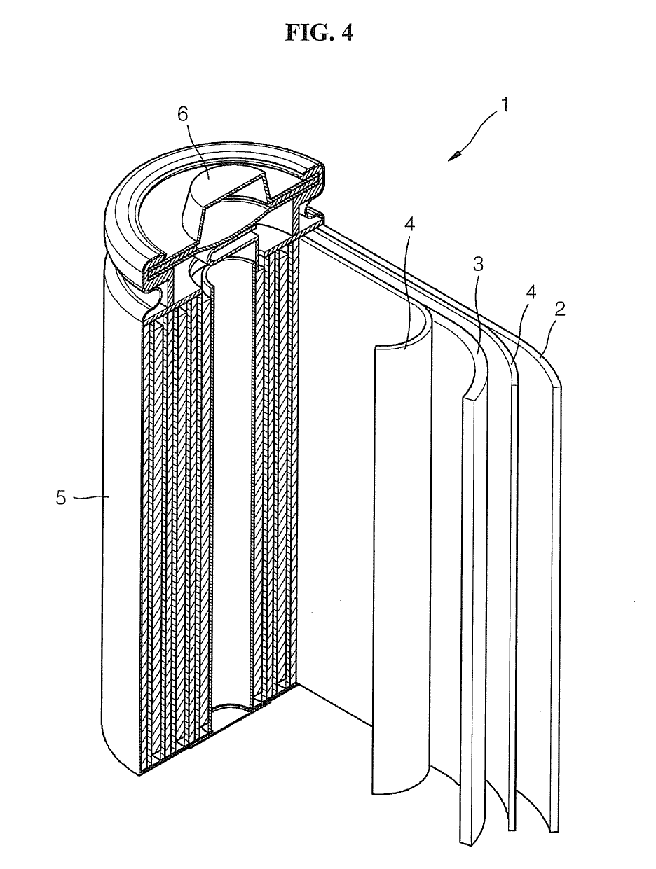

As illustrated in FIG. 4, a lithium battery 1 includes a cathode 3, an anode 2, and a separator 4. The above-described cathode 3, anode 2, and separator 4, as described above, are wound or folded to be encased in a battery case 5. Thereafter, an organic electrolyte solution is injected into the battery case 5 and sealed by a cap assembly 6 for completing the lithium battery 1. The battery case 5 may have a cylindrical shape, a square shape, or a thin film shape. For example, the battery 1 may be a large thin film type battery. The battery 1 may be a lithium-ion battery.

The separator 4 may be disposed between the cathode 3 and the anode 2 to form a battery structure. The battery structure is layered as a bicell structure and is impregnated in an organic electrolyte solution, and then the structure obtained is accommodated in a pouch and is sealed to complete a lithium-ion polymer battery. Also, a plurality of the battery structures may be layered for forming a battery pack, and the battery pack may be used for any high-capacity and high-output devices. For, example, the battery pack may be used for a notebook computer, a smartphone, or an electric vehicle. Further, since the lithium battery has excellent storage stability, life characteristics, and high rate characteristics under high temperature conditions, the lithium battery may be used in an electric vehicle (EV). For example, the lithium battery may be used in a hybrid vehicle such as a plug-in hybrid electric vehicle (PHEV).

A method of manufacturing an electrode active material according to another embodiment includes preparing a resultant by contacting a composite metal halide or its precursor containing an alkali metal and a metal with an oxidation number of 2 or higher to a core including a cathode active material or an anode active material capable of intercalating and deintercalating lithium; and optionally sintering the resultant. The resultant may include a precipitate, mixture, or the like. The sintering may be necessary when a precursor of a composite metal halide is used and may be omitted when a composite metal halide is used.

The precursor may include a salt including an alkali metal and a metal with an oxidation number of 2 or higher. For example, each of the salt including an alkali metal and a metal with an oxidation number of 2 or higher may be one salt selected from the group consisting of a fluoride salt, a chloride salt, a bromide salt and an iodide salt.

In the method described above, the content of the composite metal halogen or its precursor may be about 10 wt% or less of the total weight of both the core and the composite metal halogen or its precursor. For example, the content of the composite metal halogen or its precursor may be about 5 wt% or less of the total weight of both the core and the composite metal halogen or its precursor. For example, the content may be larger than about 0 and up to about 10 wt%. For example, the content may be larger than about 0 and up to about 5 wt%.

In the method described above, the contacting may be performed in air or in a solution. That is, the contacting may be carried out by dry coating or wet coating. The wet coating may be any method known to a person of ordinary skill in the art such as spray, coprecipitation, dipping, or the like. The dry coating may be any method known to a person of ordinary skill in the art such as mixing, milling, granulation, or the like.

In the method described above, the air in which the contacting is performed is not limited to air but refers to all types of gas such as oxygen, nitrogen, argon, and the like. For example, the electrode active material may be manufactured by mixing the core and the composite metal halide or its precursor in the form of powder in air or nitrogen atmosphere using ball mill or the like and then optionally sintering. The term “optionally” means that the sintering may be omitted.

The electrode active material may be manufactured by mixing the core and the composite metal halide or its precursor in a solution state, removing the solvent, and optionally sintering. The solvent may be water or an organic solvent such as ethanol, acetone, propylene carbonate, diethyl carbonate, methylene chloride, hexane, or the like, but is not limited thereto, and any solvent available in the field of the art may be used. For example, the electrode active material may be manufactured by immersing the core in a solution including the precursor of the halide, separating the core from the solution, and sintering.

The electrode active material may be manufactured by coprecipitating the core and the precursor in a solution including both the core and the precursor of the halide, separating the electrode active material from the solution, and sintering. For example, the electrode active material may be manufactured by mixing a slurry including the core and the precursor of the halide, drying and sintering.

In the method described above, the sintering may be performed at a temperature within the range of about 0 to about 1000° C. For example, the sintering may be performed at a temperature within the range of about 500 to about 1000° C. For example, the sintering may be performed at a temperature within the range of about 700 to about 950° C. An electrode active material with an improved property of matter may be synthesized within the sintering temperature range above.

In the method described above, the sintering may be performed for about 1 to about 24 hours. For example, the sintering may be performed for about 3 to about 24 hours. For example, the sintering may be performed for about 6 to about 24 hours. For example, the sintering may be performed for about 6 to about 12 hours. An electrode active material with an improved property of matter may be synthesized within the sintering time range above.

In the method described above, the sintering may be performed in an inert atmosphere. For example, the sintering may be performed in a nitrogen, argon, helium, vacuum or a mixture thereof atmosphere. When the sintering is performed in an atmosphere including oxygen, a metal oxide may be formed.

Hereinafter, the present disclosure will be described in detail through embodiments and comparative examples. The embodiments are just for exemplification of the present disclosure, and the present disclosure is not limited thereto.

(Manufacturing surface-treated OLO cathode active material)

### Example 1

LiF and AIF₃ were mixed at a ratio of about 3:1, and then Li_{1.1}Ni_{0.35}Mn_{0.41}Co_{0.14}O₂ with an average diameter of about 15 μm was added and mixed on a mortar. The mixture was heated starting at a temperature of about 0° C. and increased in a nitrogen atmosphere, and then the mixture was sintered at a temperature of about 800° C. for about 12 hours to manufacture a cathode active material including an Li_{1.1}Ni_{0.35}Mn_{0.41}Co_{0.14}O₂ core of which a coating layer is formed including Li₂AlF₆ on a surface thereof.

The content of the composite metal halide precursor used was about 3 wt% of the total weight of both the composite metal halide precursor and Li_{1.1}Ni_{0.35}Mn_{0.41}Co_{0.14}O₂.

### Example 2

A cathode active material was manufactured using the same method as in Example 1 except for using H₂TiF₆ and Li₂CO₃ at a ratio of about 1:1 as a composite metal halide precursor to form a coating layer including Li₂TiF₆.

### Example 3

A cathode active material was manufactured using the same method as in Example 1 except for using H₂ZrF₆ and Li₂CO₃ at a ratio of about 1:1 as a composite metal halide precursor to form a coating layer including Li₂ZrF₆.

### Example 4

A cathode active material was manufactured using the same method as in Example 1 except for using LiF and FeF₃ at a ratio of about 3:1 as a composite metal halide precursor to form a coating layer including Li₃FeF₆.

### Example 5

A cathode active material was manufactured using the same method as in Example 1 except for using LiF and CoF₃ at a ratio of about 3:1 as a composite metal halide precursor to form a coating layer including Li₃CoF₆.

### Example 6

A cathode active material was manufactured using the same method as in Example 1 except for using H₂HfF₆ and Li₂CO₃ at a ratio of about 1:1 as a composite metal halide precursor to form a coating layer including Li₂HfF₆.

### Examples 7˜12

Cathode active materials having coating layers were respectively manufacture using the same methods as in Examples 1 to 6 except that the composite metal halide precursor content was changed to about 1 wt%.

### Examples 13˜18

Cathode active materials having coating layers were respectively manufacture using the same methods as in. Examples 1 to 6 except that the composite metal halide precursor content was changed to about 5 wt%.

### Examples 19˜24

Cathode active materials having coating layers were respectively manufacture using the same methods as in Examples 1 to 6 except that the composite metal halide precursor content was changed to about 10 wt%.

### Example 25 (Wet method)

A precursor solution was prepared by adding LiF and AlF₃ at a mixture ratio of about 3:1 to a mixed solvent of water and ethanol (volume ratio about 1:1). A mixed solution was prepared by adding Li_{1.1}Ni_{0.35}Mn_{0.41}Co_{0.14}O₂ with an average diameter of about 15 μm in the precursor solution. A dried resultant was obtained by drying the mixed solution. The dried resultant was sintered in a nitrogen atmosphere at about 800° C. for about 12 hours, and a cathode active material including Li_{1.1}Ni_{0.35}Mn_{0.41}Co_{0.14}O₂ core of which a coating layer is formed including Li₂AlF₆ on a surface thereof was manufactured.

The content of the composite metal halide precursor used was about 3 wt% of the total weight of both the composite metal halide precursor and Li_{1.1}Ni_{0.35}Mn_{0.41}Co_{0.14}O₂.

### Example 26

A cathode active material was manufactured using the same method as in Example 25 except for using H₂TiF₆ and Li₂CO₃ at a ratio of about 1:1 as a composite metal halide precursor to form a coating layer including Li₂TiF₆.

### Example 27

A cathode active material was manufactured using the same method as in Example 25 except for using H₂ZrF₆ and Li₂CO₃ at a ratio of about 1:1 as a composite metal halide precursor to form a coating layer including Li₂ZrF₆.

### Comparative Example 1

Li_{1.1}Ni_{0.35}Mn_{0.41}Co_{0.14}O₂ having an average particle diameter of about 15 μm was directly used as a cathode active material without manufacturing a coating layer.

### Comparative Example 2

A cathode active material was manufactured using the same method as in Example 1 except for using aluminum nitrate (Al(NO₃)₃) as a precursor to form a coating layer including Al₂O₃ on a surface of Li_{1.1}Ni_{0.35}Mn_{0.41}CO_{0.14}O₂.

The content of the composite metal halide precursor used was about 3 wt% of a total weight of both the composite metal halide precursor and Li_{1.1}Ni_{0.35}Mn_{0.41}Co_{0.14}O₂.

(Manufacturing cathode)

### Example 28

A cathode active material manufactured according to Example 1, a carbon conducting agent (acetylene black) and PVDF were mixed at a weight ratio of about 94:3:3, and then the mixture was mixed with NMP in an agate mortar to manufacture slurry. The slurry was bar coated on an aluminum current collector having a thickness of about 15 μm, was dried at room temperature, and then was dried once again under vacuum conditions and at a temperature of about 120° C. and was rolled and punched to form a cathode plate with a thickness of about 55 μm on which a cathode active material layer was formed.

### Examples 29˜54

Cathode plates were manufactured using the same method as in Example 28 except that cathode active materials of Examples 2 to 27 were respectively used.

### Comparative Examples 3˜4

Cathode plates were manufactured using the same method as in Example 28 except that cathode active materials of Comparative Examples 1 to 2 were used.

(Manufacturing lithium battery, Li counter electrode)

### Example 55

A coin cell was manufactured using a cathode plate manufactured according to Example 27, lithium metal as a counter electrode, and a solution, in which a PTFE separator and 1.3M LiPF₆ were dissolved by ethylene carbonate (EC)+diethyl carbonate (DEC)+dimethyl carbonate (DMC) (volume ratio about 3:5:2), as an electrolyte.

### Examples 56˜81

Coin cells were manufactured using the same methods as in Example 55 except that cathode plates manufactured according to Examples 29 to 54 were respectively used.

### Comparative Examples 5˜6

Coin cells were manufactured using the same methods as in Example 55 except that cathode plates manufactured according to Comparative Examples 3 to 4 were respectively used.

(Manufacturing lithium battery, graphite counter electrode)

### Example 82

An anode was manufactured using the same method as in Example 28 except using a graphite power (Osaka gas, MCMB) as an anode active material.

A coin cell was manufactured using the cathode plate manufactured in Example 28, the anode plate, a PTFE separator, and a solution in which about 1.3 M LiPF₆ is dissolved in EC+DEC+DMC (volume ratio about 3:5:2) as an electrolyte.

### Examples 83˜108

Coin cells were manufactured using the same methods as in Example 82 except that cathodes manufactured according to Examples 29 to 54 were respectively used.

### Comparative Examples 7˜8

Coin cells were manufactured using the same methods as in Example 82 except that cathodes manufactured according to Comparative Examples 3 to 4.

Evaluation Example 1: XRD experiment (1)

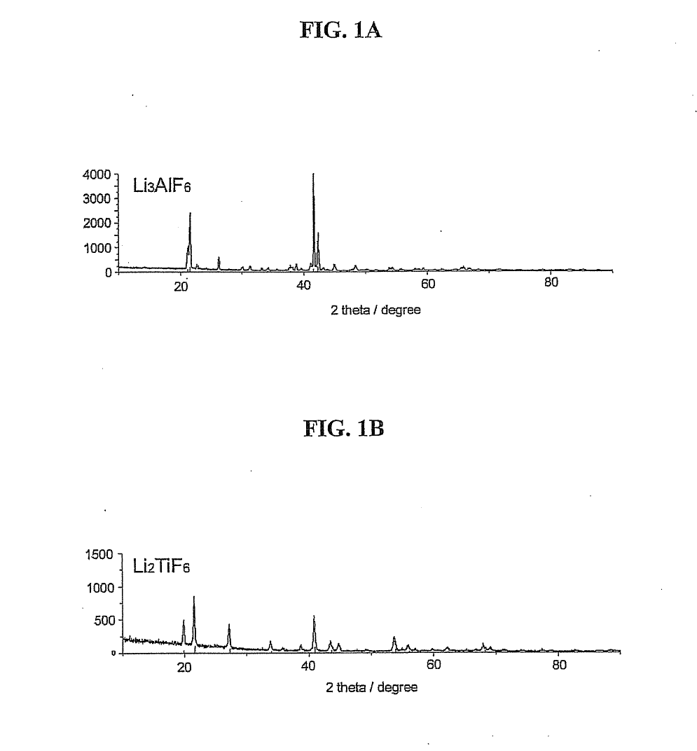

An XRD experiment was performed on each surface of cathode active materials manufactured according to Examples 1 to 2 and Comparative Example 1 and separately synthesized Li₃AlF₆ and Li₂TiF₆. Some results thereof are illustrated in FIGS. 1A and 1B.

FIG. 1A illustrates the result of an XRD experiment performed with respect to Li₃AlF₆ solely synthesized by mixing LiF and AlF₃ at a ratio of about 3:1 and sintering the mixture in a nitrogen atmosphere at about 800° C. for about 12 hours. This is a reference material.

FIG. 1B illustrates the result of an XRD experiment performed with respect to Li₂TiF₆ solely synthesized by mixing H₂TiF₆ and Li₂CO₃ at a ratio of about 1:1 and sintering the mixture in a nitrogen atmosphere at about 800° C. for about 12 hours. This is a reference material.

The cathode active material manufactured in Comparative Example 1 did not show characteristic peaks corresponding to Li₃AlF₆ and Li₂TiF₆ shown in FIGS. 1A and 1B.

Evaluation Example 2: ion-coupled plasma (ICP) experiment

An ICP experiment was performed on a surface of the cathode active material manufactured according to Example 1.

The device used to perform the ICP experiment was the model ICPS-8100 of Shimadzu Corporation. The composition ratio of Al:F on the cathode active material surface was about 3:1.

Evaluation Example 3: transmission electron microscopy (TEM) experiment

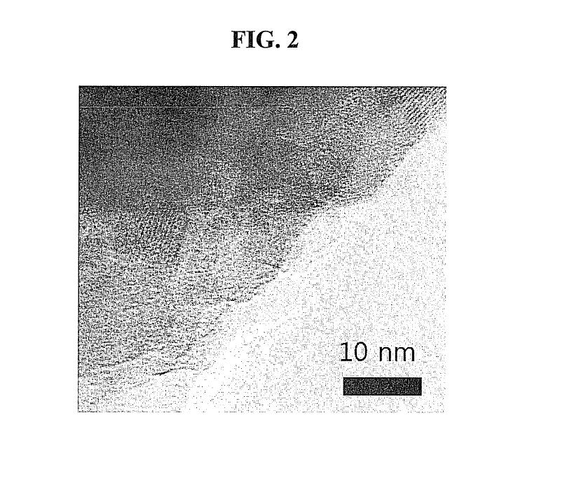

A TEM image of the surface of the cathode active material manufactured by Example 1 was obtained. The obtained image is shown in FIG. 2. As shown in FIG. 2, a coating layer is formed on the surface of an active material core. The thickness of the coating layer was from about 3 to about 10 nm.

Evaluation Example 4: stability experiment at a hiqh temperature of about 90° C.

Constant-current charging was performed on coin cells manufactured according to Examples 55 to 81 and Comparative Examples 5 to 6 to a voltage of 4.45 V at a rate of 0.05 C, and constant-current discharging was performed to a voltage of 3.0 V at a rate of 0.05 C in a first cycle. In a second cycle, constant-current charging was performed to a voltage of 4.45 V at a rate of 0.1 C, and then constant-voltage charging was performed until a current became 0.05 C while maintaining the voltage at 4.45 V, and constant-current discharging was performed to a voltage of 3.0 V at a rate of 0.1 C. In a third cycle, constant-current charging was performed to a voltage of 4.45 V at a rate of about 0.5 C, and then constant-voltage charging was performed to a current became about 0.05 C while maintaining a voltage at 4.45 V, and constant-current discharging was performed to a voltage of 3.0 V at a rate of 0.2 C. In the third cycle, discharge capacity was considered as standard capacity.

In a fourth cycle, a charging operation was performed to a voltage of 4.45 V at a rate of 0.5 C, and then constant-voltage charging was performed until a current became 0.05 C while maintaining a voltage at 4.45 V. Thereafter, the charged batteries were stored in an oven at a temperature of 90° C. for eight days, and then were removed to be discharged until a voltage of 3.0 V at a rate of 0.2 C. Some results of the charging and discharging operations are shown in Table 1 below. A capacity retention ratio after high temperature storage is defined as expressed in the following Equation 1.

<Equation 1>

Capacity retention ratio after high temperature storage [%]=discharge capacity after high temperature storage in a fourth cycle/standard capacity 100

(The standard capacity is discharge capacity in the third cycle:)
Evaluation Example 5: stability experiment at a high temperature of about 60° C.

The stability experiment was performed on coin cells manufactured according to Examples 55 to 81 and Comparative Examples 5 to 6 using the same method as in the Evaluation of Example 4 except that the charged batteries were stored in an oven at a temperature of 60° C. for 7 days. Some results of the charging and discharging operations are shown in Table 1 below. A capacity retention ratio after high temperature storage is defined as expressed in Equation 1 above.

TABLE 1

| | Capacity retention ratio | Capacity retention ratio |
|---|---|---|
| | after storage at 90° C. | after storage at 60° C. for 7 |
| | for 8 days [%] | days [%] |
| Comparative | 79.8 | 78.6 |
| Example 5 | | |
| Example 55 | 92.1 | 78.3 |
| Example 56 | 82.4 | 81.5 |
| Example 57 | 82.0 | 79.0 |

As shown in Table 1, capacity retention ratios after high temperature storage of the lithium batteries of Examples 55 to 57 were improved in comparison with the lithium batteries of Comparative Example 5. That is, stability at high temperature of the lithium batteries of Examples 55 to 57 was improved.

Evaluation Example 6: high temperature charge/discharge experiment

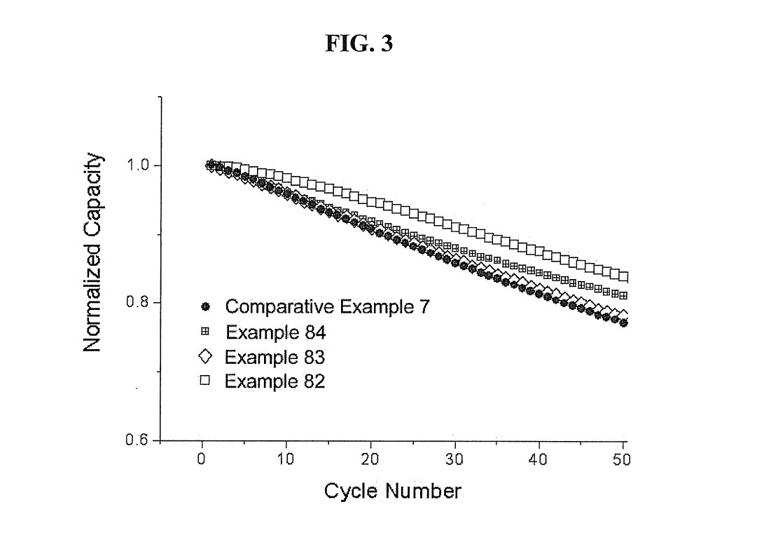

Coin cells manufactured according to Examples 82 to 108 and Comparative Examples 7 to 8 were charged/discharged 50 times with a constant current of about 1 C rate in the voltage range of 3.0 V to 4.45 V (vs. Li) at a high temperature of 45° C. The life characteristic in a 50^{th} cycle is shown in FIG. 3 and Table 2.

TABLE 2

| | Retention ratio in 50^{th} cycle [%] |
|---|---|
| Comparative Example 7 | 77.2 |
| Example 82 | 81.2 |
| Example 83 | 78.2 |
| Example 84 | 89.9 |

As shown in Table 2 and FIG. 3, life characteristics at high temperature of the lithium batteries of Examples 82 to 84 were improved in comparison with the lithium batteries of

### Comparative Example 7.

Evaluation Example 7: room temperature charqe/discharge experiment

Coin cells manufactured according to Examples 82 to 108 and Comparative Examples 7 to 8 were charged/discharged 50 times with a constant current rate of 1 C in the voltage range of 3.0 V to 4.45 V (vs. Li) at a high temperature of 25° C.

As a result, life characteristics of the lithium batteries of Examples 82 to 84 were similar to that of the lithium batteries of Comparative Example 7. In other words, life-span of the batteries was not reduced.

Evaluation Example 8: high rate characteristics experiment

Coin cells manufactured according to Examples 55 to 81 and Comparative Examples 5 to 6 were charged with a constant current rate of 0.1 C in the voltage range of 3.5 V to 4.9 V at room temperature, and discharge capacity in regard of increase in current densities during discharge was measured. Rate capabilities were calculated and shown in Table 3. The current densities during discharge were at a rate of 0.5 C and 2 C, respectively. A rate capability is defined as expressed in the following Equation 2.

<Equation 2>

Rate Capability [%]=[discharge capacity at 2 C/discharge capacity at 0.5 C] 100

TABLE 3

| | Rate Capability [%] |
|---|---|
| Comparative Example 5 | 68.7 |
| Example 55 | 75.4 |
| Example 56 | 76.5 |
| Example 57 | 73.3 |

As shown in Table 3, rate capabilities of the lithium batteries of Examples 55 to 57 were improved in comparison with the lithium batteries of Comparative Example 5.

According to an aspect of the present invention, since a core capable of intercalating and deintercalating lithium is coated with a composite metal halide including an alkali metal and a metal with an oxidation number of 2 or higher, high temperature stability, high temperature life characteristics, and high rate characteristics of a lithium battery may be improved.

It should be understood that the exemplary embodiments described therein should be considered in a descriptive sense only and not for purposes of limitation. Descriptions of features or aspects within each embodiment should typically be considered as available for other similar features or aspects in other embodiments.Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode active material, comprising:
a core capable of intercalating and deintercalating lithium; and
a coating layer formed on at least a portion of a surface of the core,
wherein the coating layer comprises a composite metal halide comprising an alkali metal and a metal with an oxidation number of 2 or higher.

2. The electrode active material of claim 1, wherein the composite metal halide is expressed as Formula 1 below:
AₐMeX_{b}, <Formula 1>
where A is one or more metals selected from the group consisting of lithium (Li), sodium (Na), and potassium (K),
Me is one or more selected from the group consisting of aluminum (Al), iron (Fe), titanium (Ti), zirconium (Zr), scandium (Sc), vanadium (V), chrome (Cr), manganese (Mn), cobalt (Co), nickel (Ni), copper (Cu), zinc (Zn), molybdenum (Mo), ruthenium (Ru), lanthanum (La), Hafnium (Hf), Niobium (Nb), germanium (Ge), silver (Ag), tungsten (W), and silicon (Si),
X is a halogen,
a is an integer from 1 to 3, and
b is an integer from 4 to 6.

3. The electrode active material of claim 1, wherein the composite metal halide is one or more metal halides selected from the group consisting of Li₂TiF₆, Na₂TiF₆, K₂TiF₆, Li₂ZrF₆, Na₂ZrF₆, K₂TiF₆, Li₃AlF₆, Na₃AlF₆, K₃TiF₆, Li₃FeF₆, NaFeF₆, Na₃FeF₆, Na₂AlF₆, K₃AlF₆, K₃FeF₆, K₂ZrF₆, LiₓNa₂₋ₓTiF₆(0<x<2), Li_{y}K_{1-y}TiF₆(0<y<1), Li₂Zr_{0.5}Ti_{0.5}F₆, Li₃Al_{0.5}Fe_{0.5}F₆, Li₃MoF₆, Li₂MoF₆, LiMoF₆, and Li₃HfF₆.

4. The electrode active material of claim 1, wherein the composite metal halide content is about 10 wt% or less based on the total weight of the electrode active material.

5. The electrode active material of claim 1, wherein the composite metal halide content is about 5 wt% or less based on the total weight of the electrode active material.

6. The electrode active material of claim 1, wherein the coating layer comprises:
one or more elements selected from the group consisting of alkali metals;
one or more elements selected from the group consisting of metals with an oxidation number of 2 or higher; and
one or more elements selected from the group consisting of halogens.

7. The electrode active material of claim 6, wherein the metal with an oxidation number of 2 or higher is a metal selected from the group consisting of Al, Fe, Ti, Zr, Sc, V, Cr, Mn, Co, Ni, Cu, Zn, Mo, Ru, La, Hf, Nb, Ge, Ag, W and Si.

8. The electrode active material of claim 1, wherein the composition ratio of halogen element to the one or more metals with an oxidation number of 2 or higher is about 3.5:1 to about 6.5:1 in the coating layer.

9. The electrode active material of claim 1, wherein the composition ratio of alkali metal elements to the one or more metals with an oxidation number of 2 or higher is about 0.5:1 to about 3.5:1 in the coating layer.

10. The electrode active material of claim 1, wherein the composite metal halide does not intercalate or deintercalate lithium.

11. The electrode active material of claim 1, wherein the thickness of the coating layer ranges from about 1 Å to about 1 μm.

12. The electrode active material of claim 1, wherein the core comprises a cathode active material.

13. The electrode active material of claim 1, wherein the core comprises a lithium transition metal oxide.

14. The electrode active material of claim 1, wherein the core comprises an overlithiated lithium transition metal oxide (OLO).

15. The electrode active material of claim 1, wherein the core compounds are expressed as the following Formulae 2 and 3
Li[LiₐMe₁₋ₐ]O_{2+d} <Formula 2>
Li[Li_{b}Me_{c}M′ₑ]O_{2+d}, <Formula 3>
,where 0<a<1, b+c+e=1; 0<b<1, 0<e<0.1; 0≦d≦0.1,
Me is one or more metals selected from the group consisting of Ti, V, Cr, Mn, Fe, Co, Ni, Cu, Al, Mg, Zr, and B, and
M′ is one or more metals selected from the group consisting of Mo, W, Ir, Ni, and Mg.

16. The electrode active material of claim 1, wherein the core comprises compounds expressed as the following Formulae 4 to 8
LiₓCo_{1-y}M_{y}O_{2-α}X_{α} <Formula 4>
LiₓCo_{1-y-z}Ni_{y}M_{z}O_{2-α}X₆₀ <Formula 5>
LiₓMn_{2-y}M_{y}O_{4-α}X₆₀ <Formula 6>
LiₓCo_{2-y}M_{y}O_{4-α}X₆₀ <Formula 7>
LiₓMe_{y}M_{z}PO_{4-α}X_{α}, <Formula 8>
wherein 0.90≦x≦1.1, 0≦y≦0.9, 0≦z≦0.5, 1−y−z>0, 0≦α≦2,
Me is one ore more metals selected from the group consisting of Ti, V, Cr, Mn, Fe, Co, Ni, Cu, Al, Mg, Zr and B,
M is one or more elements selected from the group consisting of Mg, Ca, Sr, Ba, Ti, Zr, Nb, Mo, W, Zn, Al, Si, Ni, Mn, Cr, Fe, Mg, Sr, V and rare-earth elements, and
X is an element selected from the group consisting of O, F, S, and P.

17. The electrode active material of claim 1, wherein the core comprises compounds expressed as the following Formulas 9 and 10
pLi₂MO₃—(1−p)LiMeO₂ <Formula 9>
xLi₂MO₃−yLiMeO₂−zLi_{1+d}M′_{2-d}O₄, <Formula 10>
,where 0<p<1,x+y+z=1; 0<x<1, 0<y<1, 0<z<1; 0≦d≦0.33,
M is one or more metals selected from the group consisting of Mg, Ca, Sr, Ba, Ti, Zr, Nb, Mo, W, Zn, Al, Si, Ni, Mn, Cr, Fe, Mg, Sr, V and rare-earth elements,
Me is one or more metals selected from the group consisting of Ti, V, Cr, Mn, Fe, Co, Ni, Cu, Al, Mg, Zr and B, and
M′ is one or more metals selected from the group consisting of Ti, V. Cr, Mn, Fe, Co, Ni, Cu, Al, Mg, Zr and B.

18. The electrode active material of claim 1, wherein the core comprises an anode active material.

19. The electrode active material of claim 1, wherein the core comprises one or more materials selected from the group consisting of lithium metal, a metal which is alloyable with lithium, a transition metal oxide, a non-transition metal oxide, and a carbonaceous material.

20. The electrode active material of claim 1, wherein the core comprises one or more materials selected from the group consisting of Si, Sn, Al, Ge, Pb, Bi, Sb, Si—Y alloy, Sn—Y alloy, lithium titanium oxide, vanadium oxide, lithium vanadium oxide, SnO₂, SiOₓ (o<x<2), natural graphite, artificial graphite, soft carbon, hard carbon, mesophase pitch carbide, and sintered coke, wherein Y is Mg, Co, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

21. The electrode active material of claim 1, wherein the coating layer is formed by contacting the composite metal halide containing a metal with an oxidation number of 2 or higher or its precursor with the core.

22. The electrode active material of claim 21, wherein the precursor of the composite metal halide is sintered.

23. An electrode comprising an electrode active material according to claim 1.

24. The electrode of claim 23, wherein the electrode is a cathode.

25. The electrode of claim 23, wherein the electrode is an anode.

26. A lithium battery comprising an electrode according to claim 21.

27. A method of manufacturing an electrode active material, comprising:
preparing a resultant by contacting a metal halide or its precursor containing an alkali metal and a metal with an oxidation number of 2 or higher with a core including a cathode active material or an anode active material.

28. The method of claim 27, wherein the precursor comprises a salt comprising an alkali metal and a salt comprising a metal with an oxidation number of 2 or higher.

29. The method of claim 28, wherein the salt is one or more salts selected from the group consisting of a fluoride salt, a chloride salt, a bromide salt and an iodide salt.

30. The method of claim 27, wherein the content of the composite metal halogen or its precursor is about 10 wt% or less based on the total weight both the core and the composite metal halogen or its precursor.

31. The method of claim 27, wherein the content of the composite metal halogen or its precursor is about 5 wt% or less based on the total weight both the core and the composite metal halogen or its precursor.

32. The method of claim 27, wherein the contacting is performed in air or in a solution.

33. The method of claim 27, further comprising sintering the resultant.

34. The method of claim 33, wherein the sintering is performed at a temperature of about 0° C. to about 1000° C. for about 1 hour to about 24 hours.

35. The method of claim 33, wherein the sintering is performed in an inert atmosphere.
